(19) United States
(12) Patent Application Publication
(10) Pub. No.: US 2018/0296964 A1
(43) Pub. Date: Oct. 18, 2018

(54) USE OF COMPOSITE MATERIAL IN CONSTRUCTION MATERIAL, CONSTRUCTION MATERIAL AND METHOD FOR AIR PURIFICATION

(71) Applicant: Solvay Acetow GmbH, Freiburg (DE)

(72) Inventor: Eckart Schutz, Gundelfingen (DE)

(21) Appl. No.: 15/766,939

(22) PCT Filed: Oct. 6, 2016
(86) PCT No.: PCT/EP2016/073910

§ 371 Date: Apr. 9, 2018

(30) Foreign Application Priority Data
Oct. 7, 2015 (EP) 15188757.7

(51) Int. Cl. B01D 53/02; C08L 1/12

(52) U.S. Cl. CPC B01D 53/02; C08K 3/04; C08L 1/12

(57) ABSTRACT

The present invention the use of a composite material in construction material or a decorative object, construction material or a decorative object comprising composite material, a method for air purification and a process for the manufacture of construction material or a decorative object capable of air purification.

This application claims priority to European application No. EP 15188757.7, the whole content of this application being incorporated herein by reference for all purposes.

The present invention concerns the use of a composite material as a component of a construction material or of a decorative object for reducing odours and/or hazardous substances in the gas phase, construction material or a decorative object comprising composite material, a method for air purification and a process for the manufacture of construction material or a decorative object capable of air purification.

Quality of air, in particular in domestic building, but also public buildings, industrial plants and also confined spaces like vehicles, is of great concern to ensure that humans and animals are not adversely affected. Numerous materials used in constructing buildings or vehicles can emit odours and/or hazardous substances into the gas phase, in particular when the construction of the buildings or vehicles has only recently been finalized. Examples for substances released are formaldehyde, acetaldehyde, benzene, chloroform and other organic matter. In other cases, activities in buildings, like chemical processes, meal preparation or cigarette smoking, carry new unwanted odours and/or hazardous chemical substances into the gas phase. Sometimes, odours and/or hazardous substances are released into the gas phase by deterioration processes, such as release of ammonia gas from ammonium salts included in concrete by the alkaline environment of the concrete. Other unwanted odours may evolve from mildew formation or bacterial colonization of construction material.

CN102345249A discloses a photocatalytic wallpaper which has an air purification function. Photocatalysts rely on light in the correct wavelength to be present, may decompose their substrate (e.g. wallpaper) and may also be limited in formulation to be applied to its substrate.

It is an object of the present invention to provide the use of a composite material comprising at least one polymer (P) and at least one compound (C) selected from the group consisting of mineral oxides, silicoaluminates and activated carbon in construction material or a decorative object. By using the composite material in this manner, the quality of air in buildings and confined spaces can be improved and adverse effects on humans and animals be reduced or eliminated. In another aspect, the invention concerns a method for air purification by applying construction material or a decorative object comprising at least one composite material as defined above to an object, in particular a building or a vehicle. It is a further aspect of the present invention to provide a process for the manufacture of construction material or a decorative object capable of air purification by incorporating at least one composite material as defined above into construction material or a decorative object.

It was surprisingly found that using the composite material as defined below can effectively reduce odours and/or hazardous substances in the gas phase, while showing good properties when being formulated in construction material or a decorative object. The effect is independent of, for example, light (as opposed to photocatalysts), and can be achieved also when the composite material is formulated in deeper layers of the construction material, or is applied, for example, in a paint formulation onto the construction material, due to the pores of the composite material. The polymers comprised in the composite material are non-hazardous and mostly degradable, which is important in view of sustainable disposal or recycling of the construction material. The composite materials generally can be well adapted to the application with a given construction material while not adversely affecting the properties of the construction material. The use of the composite material according to the present invention allows the effective incorporation of compound C in construction material, while, when incorporating compound C alone, formulation and dusting issues may arise.

In the present specification, the plural form and the singular form are used interchangeably. Thus, it should be understood that the plural form also includes the singular form and vice-versa, unless otherwise indicated herein or clearly contradicted by context.

In the context of the present invention, “composite material” denotes a material which comprises at least one polymer (P) and at least one compound (C) selected from the group consisting of mineral oxides, silicoaluminates and activated carbon.

In the present invention, the term «construction material» denotes any material that can be used for construction of buildings or confined spaces such as vehicles, such as wood, wood composites, concrete, mortar, bricks, plaster, plastics materials, wallpaper including all paper, cloth, plastic or composite for wall decoration materials, paints, lacquers and adhesives. Preferred construction materials are paints and wallpapers. The term «decorative objects” intends to denote any objects commonly used for decoration, in particular domestic decoration, such as posters, paintings, lamp shades or furniture.

The composite material of the use according to the present is, advantageously, porous. The composite material has a number median particle size of at least 100 μm and a pore volume (Vd1), constituted of pores of diameter ranging from 3.6 to 1000 nm, of at least 0.2 cm³/g. The composite material used according to the invention generally has a median particle size equal to or more than 100 μm, or, preferably, 200 μm. In another aspect, the median particle size is at least 150 μm, notably at least 250 μm. Its median particle size generally is equal to or less than 2000 μm, preferably equal to or less than 1000 μm. In some aspects, a median particle size of larger than 250 μm, or equal to or more than 300 μm or even 400 μm has proven advantageous. In some particular embodiments, a number median particle size of equal to or more than 100 μm and equal to or less than 2000 μm, equal to or more than 100 μm and equal to or less than 1000 μm, equal to or more than 200 μm and equal to or less than 1000 μm, equal to or more than 200 μm and equal to or less than 900 μm, equal to or more than 200 μm and equal to or less than 1500 μm, equal to or more than 200 μm and equal to or less than 800 μm, equal to or more than 300 μm and equal to or less than 2000 μm, equal to or more than 300 μm and equal to or less than 1000 μm, equal to or more than 400 μm and equal to or less than 2000 μm, equal to or more than 400 μm and equal to or less than 1000 μm, equal to or more than 400 μm and equal to or less than 800 μm, equal to or more than 450 μm and equal to or less than 1200 μm, equal to or more than 450 μm and equal to or less than 1000 μm, equal to or more than 400 μm and equal to or less than 800 μm, equal to or more than 500 μm and equal to or less than 1000 μm, equal to or more than 540 μm and equal to or less than 900 μm, equal to or more than 500 μm and equal to or less than 800 μm, equal to or more than 540 μm and equal to or less than 800 μm, equal to or more than 600 μm and equal to or less than 1000 μm, equal to or more than 150 μm and equal to or less than 1000 μm, equal to or more than 150 μm and equal to or less than 2000 μm, equal to or more than 250 μm and equal to or less than 1000 μm, equal to or more than 250 μm and equal to or less than 1500 μm, equal to or more than 250 μm and equal to or less than 950 μm and equal to or more than 600 μm and equal to or less than 900 μm often give good results. The median particle size (D50initial) is measured by laser scattering, for example according to the standard NF X 11-666, using a MALVERN MASTERSIZER 2000 particle size analyser (from Malvern Instruments), in the absence of ultrasounds and of dispersant, the measurement liquid being degassed demineralised water (2 g of sample being dispersed in 50 ml of water with magnetic stirring) and the measurement time being 5 seconds. The value retained is the average of three measurements carried out consecutively on the same sample. The pore volumes and diameters of the pores are measured by mercury porosimetry (Micromeritics Autopore 9520 porosimeter, for example); for these measurements, the preparation of each sample may be carried out as follows: each sample is first dried for 2 hours at 90° C., under atmospheric pressure, then placed in a test vessel in the 5 minutes following this drying and degassed under vacuum, for example using a vacuum pump; the sample sizes are 0.22 g (±0.01 g); the no. 10 penetrometers are used. The pore diameters are calculated by Washburn's equation with a contact angle θ=140 degrees and a surface tension y equal to 484 dynes/cm. In the present text, pores having a diameter between 3.6 and 1000 nm are not taken into account. The pore volume (intra particle pore volume Vd1), constituted of pores of diameter ranging from 3.6 to 1000 nm, generally is equal to or more than 0.2 cm³/g, or even 0.3 cm³/g, wherein cm³/g denotes cm³ per gram of composite material. In another aspect, Vd1 is is equal to or more than 0.4 cm³/g. Generally, Vd1 is is equal to or less than 3.0 cm³/g. This is to say the pore volume is defined to accumulate from pores of diameter between 3.6 and 1000 nm. The pore volume (Vd1) is, in general, at least 0.3 cm³/g (for example between 0.3 and 3.0 cm³/g), preferably (especially in the case where the compound (C) is activated carbon) at least 0.4 cm³/g, in particular between 0.4 and 3.0 cm³/g, for example between 0.4 and 2.0 cm³/g, even between 0.45 and 1.5 cm³/g. Especially in the case where the compound (C) is silica (preferably precipitated silica), the pore volume (Vd1) of the composite material according to the invention may be at least 0.5 cm³/g, in particular between 0.5 and 3.0 cm³/g, for example between 0.5 and 2.0 cm³/g, even between 0.55 and 1.5 cm³/g. Still more preferably, its pore volume (Vd1) is at least 0.7 cm³/g, in particular between 0.7 and 3.0 cm³/g, especially between 0.7 and 2.0 cm³/g, for example between 0.75 and 1.5 cm³/g.

In another embodiment, the pore volume (Vd1) is, in general, at least 0.5 cm³/g, in particular between 0.5 and 3.0 cm³/g, for example between 0.5 and 2.5 cm³/g, even between 0.5 and 2.0 cm³/g. Notably in the case where the compound (C) is silica (preferably precipitated silica), the pore volume (Vd1) of the composite material according to the invention may be of at least 0.6 cm³/g, in particular between 0.6 and 3.0 cm³/g, preferably between 0.6 and 2.0 cm³/g, for example between 0.7 and 1.5 cm³/g, even between 0.7 and 1.4 cm³/g. Still more preferably, its pore volume (Vd1) is at least 0.8 cm³/g, in particular between 0.8 and 3.0 cm³/g, especially between 0.8 and 2.0 cm³/g, for example between 0.9 and 1.4 cm³/g.

The composite material used according to the invention preferentially does not generate dust during its handling.

The composite material used according to the invention may have, especially when the compound (C) is silica, in particular precipitated silica, an average pore diameter, for the pores of diameter between 3.6 and 1000 nm, greater than 11 nm (for example, between 11 (exclusive) and 100 nm or between 11 (exclusive) and 50 nm), preferably at least 11.5 nm, for example between 11.5 and 100 nm; it may be between 11.5 and 50 nm, in particular between 11.5 and 40 nm, especially between 12 and 40 nm, for example between 12 and 25 nm or between 12 and 17 nm; it may also vary between 13 and 40 nm, in particular between 13 and 25 nm, for example between 13.5 and 25 nm, even between 13.5 and 17 nm.

In another embodiment, the composite material used according to the invention may have, especially when the compound (C) is silica, in particular precipitated silica, an average pore diameter, for the pores of diameter between 3.6 and 1000 nm, of at least 9 nm (for example between 9 and 100 nm or between 9 and 50 nm), preferably greater than 11 nm (for example, between 11 (exclusive) and 100 nm or between 11 (exclusive) and 50 nm), especially of at least 12 nm, for example between 12 and 100 nm; it may be between 12 and 50 nm, in particular between 12 and 25 nm or between 12 and 18 nm; it may also vary between 13 and 25 nm, for example between 13 and 18 nm.

The composite material used according to the invention, which is advantageously in solid form, generally has a BET specific surface area of at least 50 m²/g. In general, its BET specific surface area is at most 1300 m²/g and in particular at most 1200 m²/g, especially at most 1000 m²/g, for example at most 900 m²/g, even at most 700 m²/g (m² per gram of composite material).

In another embodiment, the composite material used according to the invention, which is advantageously in solid form, generally has a BET specific surface area of at least 50 m²/g. In general, its BET specific surface area is at most 1300 m²/g and in particular at most 1200 m²/g, especially at most 1000 m²/g, for example at most 900 m²/g, even at most 700 m²/g (m² per gram of composite material). It may be less than 400 m²/g.

The BET specific surface area is determined according to the Brunauer-Emmett-Teller method described in “The Journal of the American Chemical Society”, vol. 60, page 309, February 1938 and corresponding to the standard NF ISO 9277 (December 1996). The BET specific surface area of the composite material according to the present invention may be at least 100 m²/g, in general at least 160 m²/g, preferably at least 200 m²/g (for example greater than 300 m²/g); it may be between 250 and 1300 m²/g, in particular between 280 and 1200 m²/g, for example between 280 and 800 m²/g. It may also be between 320 and 1000 m²/g, in particular between 320 and 900 m²/g, especially between 320 and 700 m²/g, even between 320 and 600 m²/g. For example, in the case where the compound (C) is silica, in particular precipitated silica, the BET specific surface area of the composite material according to the invention may be between 250 and 800 m²/g, especially between 250 and 600 m²/g; for example, in the case where the compound (C) is activated carbon, it may be between 400 and 1300 m²/g, especially between 400 and 1000 m²/g.

In another embodiment, the BET specific surface area of the composite material used according to the present invention may be of at least 100 m²/g, in general at least 160 m²/g, preferably of at least 200 m²/g (for example at least 210 m²/g); it may be between 200 and 1300 m²/g, in particular between 200 and 1000 m²/g, for example between 200 and 800 m²/g, even between 200 and 700 m²/g or between 210 and 650 m²/g. Especially, in the case where the compound (C) is silica, in particular precipitated silica, the BET specific surface area of the composite material according to the invention may be between 200 and 600 m²/g, in particular between 200 and 500 m²/g; for example between 210 and 400 m²/g, or between 210 and 300 m²/g.

The specific surface area of the composite material used in accordance with the invention is essentially a function of the specific surface area of the compound (C), its compound (C) content and the surface accessibility of the compound (C) within the composite material, which gives porosity to the polymer (P). Preferably, the composite material according to the invention retains a large part (for example at least 60 percent) of the specific surface area of the compound (C), in particular when the polymer (P) is cellulose acetate, especially in the case where the compound (C) is activated carbon and/or especially silica (preferably precipitated silica).

According to one particular embodiment, when the compound (C) is silica (preferably precipitated silica) and/or activated carbon, the composite material used according to the invention has a median particle size of at least 300 micro m (and for example at most 2000 micro m), especially between 400 and 1000 micro m, for example between 500 and 1000 micro m, a BET specific surface area greater than 300 m²/g (and for example at most 1200 m²/g), in particular between 320 and 900 m²/g, especially between 320 and 700 m²/g, for example between 320 and 500 m²/g, even between 340 and 430 m²/g.

According to another particular embodiment, when the compound (C) is silica (preferably precipitated silica) and/or activated carbon, the composite material conforming to the invention has a number median particle size (D₅₀ₙ₍ₒ₎) of at least 400 micro m (and for example of at most 2000 micro m), notably between 400 and 1000 micro m, for example between 500 and 800 micro m, a BET specific surface area of at least 200 m²/g (and for example at most 1000 m²/g), preferably between 200 and 800 m²/g, in particular between 200 and 600 m²/g, especially between 200 and 500 m²/g, for example between 200 and 400 m²/g, even between 210 and 400 m²/g or between 210 and 300 m²/g.

In general, the composite material used according to the invention has a polymer (P) content between 10 and 95 percent, preferably between 15 and 45 percent, by weight, and a compound (C) content between 5 and 90 percent, preferably between 55 and 85 percent, by weight.

The composite material used according to the invention can also comprise a plasticizer.

The composite material used according to the present invention may especially be in the form of extrudates, for example in cylindrical form, or preferentially in the form of granules, especially approximately spheroidal granules.

The composite material as used according to the present invention can be produced, for example, according to example 1 and 2 in US2011011414 or example 1 to 4 in US20100043813.

The polymer (P) comprised in the composite material as used according to the present invention is, advantageously, a porous polymer. The polymer (P) is in general chosen from the following polymers: cellulose and its derivatives (in particular cellulose acetate), starch and its derivatives, alginates and their derivatives, polyethylene, guars and their derivatives, polyvinyl alcohols and their derivatives. The polymer (P) may be, for example, one of the polymers below: cellulose, cellulose acetate, cellulose sulphate, ethyl cellulose, hydroxyethyl cellulose, methyl cellulose, hydroxymethyl cellulose, carboxymethyl cellulose, starch, carboxymethylated starch, hydroxypropyl starch, gum arabic, agar, alginic acid, sodium alginate, potassium alginate, calcium alginate, gum tragacanth, guar gum, carob bean gum, polyvinyl acetates (possibly hydrolysed), copolymers of polyvinyl acetates and vinyl esters of aliphatic carboxylic acids, polyvinyl alcohols, polyethylene, copolymers of ethylene and vinyl esters of saturated aliphatic carboxylic acids and hydrated polycyclopentadiene. In particular, the polymer (P) may be cellulose or one of its derivatives (amongst others, cellulose acetate or cellulose sulphate), polyethylene, gum arabic or a polyvinyl alcohol. More particularly, the polymer (P) may be a derivative of cellulose (for example, cellulose acetate, cellulose sulphate, ethyl cellulose, hydroxyethyl cellulose, methyl cellulose, hydroxymethyl cellulose or carboxymethyl cellulose). Most preferably, the polymer (P) is cellulose acetate.

The compound (C) comprised in the composite material as used according to the present invention generally is an adsorbent and/or a catalyst support. The compound (C) may be a mineral oxide, such as, in particular, a silica, an alumina, a zirconium oxide, a titanium oxide, an iron oxide, an aluminosilicate or a cerium oxide. In another aspect, the compound (C) may be activated carbon (in particular, coconut activated carbon). Generally, the compound (C) is chosen from silicas, aluminas, zirconium oxides, titanium oxides, iron oxides, cerium oxides, aluminosilicates and activated carbon, for example, synthetic amorphous silica. This may be a fumed silica, a colloidal silica, a silica gel, a precipitated silica or one of their mixtures. According to a preferred variant of the invention, the compound (C) is precipitated silica. This may be prepared by a reaction for precipitating a silicate, such as an alkali metal silicate (sodium silicate for example), with an acidifying agent (sulphuric acid for example) to produce a suspension of precipitated silica, then usually by separating, in particular by filtering (with production of a filter cake) the precipitated silica obtained, and finally drying (generally by spraydrying); any method may be used to prepare the precipitated silica: especially, addition of acidifying agent to a stock of silicate, total or partial simultaneous addition of acidifying agent and silicate to a stock of water and silicate. According to another preferred variant of the invention, the compound (C) is activated carbon. According to another preferred embodiment of the invention, a mixture of compounds (C), in particular a mixture of precipitated silica and activated carbon, is used. The compound (C) comprised in the composite material used according to the invention advantageously has a relatively high specific surface area. It generally has, in particular in the case of a precipitated silica and/or activated carbon, a BET specific surface area of at least 100 m²/g, preferably at least 200 m²/g, in particular greater than 450 m²/g. The compound (C) usually has a median particle size of at least 0.5 μm, in particular between 0.5 and 100 μm. When the compound (C) is precipitated silica, this size is preferably more particularly between 0.5 and 50 μm, especially between 0.5 and 20 μm, for example between 2 and 15 μm. When the compound (C) is activated carbon (in particular coconut activated carbon), this size is preferably more particularly between 1 and 80 μm, especially between 2 and 70 μm. The compound (C) comprised in the composite material used according to the invention, in particular when it is silica, especially precipitated silica, preferably has a DOP oil uptake of less than 260 ml/100 g, especially less than 240 ml/100 g, for example less than 225 ml/100 g. Its DOP oil uptake may be less than 210 ml/100 g, even 205 ml/100 g. Its DOP oil uptake may be at least 80 ml/100 g, especially greater than 145 ml/100 g, for example greater than 180 ml/100 g. The DOP oil uptake is determined according to the standard ISO 787/5 using dioctyl phthalate (the measurement is carried out on the compound (C) as is). The compound (C) comprised in the composite material used according to the invention, in particular when it is silica, especially precipitated silica, and/or activated carbon, generally has a CTAB specific surface area (outer surface area determined according to the standard NF T 45007 (November 1987)) greater than 280 m²/g, especially greater than 300 m²/g, in particular greater than 330 m²/g, for example greater than 350 m²/g; it may be less than 450 m²/g. A particular precipitated silica may especially be used having
a DOP oil uptake of less than 260 ml/100, especially less than 240 ml/100 g, in particular less than 225 ml/100 g;
a pore volume (V_{d25}), formed from pores of diameter less than 25 nm, greater than 0.8 ml/g, especially greater than 0.9 ml/g, for example at least 0.95 ml/g (pore volume determined by the method of Barett, Joyner and Halenda, known as the BJH method, described especially, by F. Rouquerol, L. Luciani, P. Llewwellyn, R. Denoyel and J. Rouquerol, in “Les Techniques de I'lngenieur”, September 2001);
a CTAB specific surface area greater than 280 m²/g, especially greater than 300 m²/g, in particular greater than 330 m²/g, for example greater than 350 m²/g; and
preferably, a BET specific surface area greater than 450 m²/g, for example greater than 510 m²/g.
   This particular precipitated silica may have a pore diameter (dp), for pores of diameter less than 25 nm, taken at the maximum of the pore size distribution by volume, of less than 12.0 nm, in particular less than 8.0 nm (method of Barett, Joyner and Halenda). It may be prepared by a method described in US2010043813.

The surface of the particles of the compound (C) comprised in the composite material used according to the invention, in particular when it is a precipitating silica, may first be functionalized, especially by grafting or absorption of organic molecules, comprising for example at least one amino, phenyl, alkyl, cyano, nitrile, alkoxy, hydroxyl, amide, thio and/or halogen functional group.

The proportions of polymer (P) and compound (C) comprised in the composite material used according to the invention depend on the proportions desired in the final composite material, and are, in general, such that the composite material has a polymer (P) content between 10 and 95 percent, preferably between 15 and 45 percent, by weight, and a compound (C) content between 5 and 90 percent, preferably between 55 and 85 percent, by weight.

Often, the composite material is applied to at least a part of the surface of the construction material or a decorative object. For example, it can be applied to wallpaper by co-formulation with a paint or adhesive which is applied to the wallpaper, or by applying paint or adhesive to a wallpaper and subsequent dry application to the wet surface of the paint of adhesive layer on the wallpaper. In another aspect, the composite material is formulated into subsurface levels of the construction material, for example by formulating the composite material into wet or pasty concrete, brick or mortar precursors.

Often, the composite material is applied to at least a part of the surface of the construction material or a decorative object. For example, it can be applied to wallpaper by co-formulation with a paint or adhesive which is applied to the wallpaper, or by applying paint or adhesive to a wallpaper and subsequent dry application to the wet surface of the paint of adhesive layer on the wallpaper. In another aspect, the composite material is formulated into subsurface levels of the construction material, for example by formulating the composite material into wet or pasty concrete, brick or mortar precursors.

Thus, the invention also concerns construction material or a decorative object comprising composite material comprising at least one polymer (P) and at least one compound (C) selected from the group consisting of mineral oxides, silicoaluminates and activated carbon. The construction material or a decorative object can be manufactured by applying the composite material to the surface of the construction material or a decorative object, for example onto an adhesive layer applied to the surface, onto wet paint or lacquer layer on the surface, or by co-formulation of the composite material with a plastic, lacquer or paint to be applied to the surface of the construction material or a decorative object. In another aspect, the composite material is mixed with a precursor of the construction material or a decorative object, for example pasty concrete precursor, dry paint pre-mix or wet brick precursor, and the resulting mix of composite material and precursor further manufactured into construction material or a decorative object comprising the composite material throughout the construction material or a decorative object; thus, the composite material is also contained in sub-surface layers of the construction material or a decorative object.

In one aspect, the composite material comprising at least one polymer (P) and at least one compound (C) is incorporated as a layer within an item of construction material, such as, for example, chip boards.

In one embodiment of the present invention, the composite material comprising at least one polymer (P) and at least one compound (C) can be used for the purification of air in a vehicle, wherein the composite material is provided to the vehicle in a permeable packaging, such as a fabric packaging or permeable container, e.g. a cartridge. In one aspect, the packaged composite material comprising at least one polymer (P) and at least one compound (C) can be used in combination with an air ventilation system in order to enhance the effectiveness of the composite material. The composite material can be combined in the packaging with other auxiliary agents, such as air drying agents. Such packaged composite material comprising at least one polymer (P) and at least one compound (C), optionally in combination with other auxiliary agents, such as air drying agents, can be used for the purification of air in a building.

The invention concerns further a method for air purification by removing odours or harzardous gaseous substances, in particular as described hereinabove, for example formaldehyde, acetaldehyde, benzene, chloroform and other organic matter, from air by applying construction material or a decorative object comprising at least one composite material comprising at least one polymer (P) and at least one compound (C) selected from the group consisting of mineral oxides, silicoaluminates and activated carbon to an object, in particular a building or a vehicle.

Another object of the present invention is a process for the manufacture of construction material or a decorative object capable of air purification by removing odours or harzardous gaseous substances from air, by incorporating at least one composite material comprising at least one polymer (P) and at least one compound (C) selected from the group consisting of mineral oxides, silicoaluminates and activated carbon into the construction material or decorative object. In one aspect, the process comprises a step of applying the composite material to the surface of the construction material or decorative object, for example onto an adhesive layer applied to the surface, onto wet paint or lacquer layer on the surface, or by co-formulation of the composite material with a plastic, lacquer or paint to be applied to the surface of the construction material or a decorative object. Consequently, at least part of the surface of the construction material or decorative object is coated with the at least one composite material. In another aspect, the process comprises a step wherein the composite material is mixed with a precursor of the construction material or decorative object, for example pasty concrete precursor, dry paint pre-mix or wet brick precursor, and the resulting mix of composite material and precursor further manufactured into construction material or a decorative object comprising the composite material throughout the construction material or a decorative object; thus, the composite material is also contained in sub-surface layers of the construction material or a decorative object.

The examples which follow are intended to illustrate the present invention without, however, limiting the scope thereof. Should the disclosure of any patents, patent applications, and publications which are incorporated herein by reference conflict with the description of the present application to the extent that it may render a term unclear, the present description shall take precedence.

### EXAMPLES

### Example 1

10 g of Rhodia FilterSorb™ are mixed with 100 mL of polystyrene perls (for example Theraline EPS perls, diameter 0.5-1.5 mm) and inserted into a bag of air permeable polyester fabric. The bad is placed in a closed glass testing box of about 5 Liter volume. The air in the glass box is spiked with 0.15 g/m³ formaldehyde. GC measurements show that the formaldehyde concentration in the air is significantly reduced after about 8 hours until almost all formaldehyde is removed from the gas phase.

### Example 2

Example 1 is repeated, but the Rhodia FilterSorb™/polystyrene perl mixture is inserted in the bad into a cartridge connected to a ventilator in the glass box, such that the air in the glass box is forced through the cartridge. The reduction of the formaldehyde in the air is significantly faster than in example 1.

### Example 3

A chip board is manufactured according to standard technologies, by mixing wood particles with an amino-formaldehyde based resin, forming a layer, adding another layer wherin wood particles, maize granulate and Rhodia FilterSorb™ are mixed with an amino-formaldehyde based resin, and adding a final layer comprising wood particles with an amino-formaldehyde based resin.

The chip board is then compressed under usual conditions, for example by applying 2 MPa and 140° C. A piece of this chip board is then subjected to headspace monitoring as applied in example 1 and 2, and compared to a chip board manufactured by the same method, but without Rhodia FilterSorb™. The chip board comprising Rhodia FilterSorb™ displays a significantly reduced amount of formaldehyde in the headspace compared with the chip board not comprising Rhodia FilterSorb™.

### Example 4

Rhodia FilterSorb™ is added to commercial dispersion paint at a load of 5 w % and applied to a piece of wallpaper. After drying, a piece of 10 cm×10 cm is cut and placed into the glass box as in example 1. The air is spiked with 0.15 g/m³ formaldehyde. GC measurements show that the formaldehyde concentration in the air is significantly reduced after about 24 hours. Using the dispersion paint without Rhodia FilterSorb™, no reduction of formaldehyde is observed in a wallpaper sample.

1. A method comprising applying a composite material comprising at least one polymer (P) and at least one compound (C) selected from the group consisting of mineral oxides, silicoaluminates and activated carbon as a component of a construction material or of a decorative object capable of reducing odors and/or hazardous substances in the gas phase.

2. The method according to claim 1, wherein the composite material has a number median particle size of at least 100 μm and a pore volume (Vd1), constituted of pores of diameter ranging from 3.6 to 1000 nm, of at least 0.2 cm³/g.

3. The method according to claim 1, wherein the at least one polymer (P) is selected from the group consisting of: cellulose, cellulose derivatives, starch, starch derivatives, alginate or alginate derivatives, polyethylene, guars, guar derivatives, polyvinyl alcohols and derivatives of polyvinyl alcohols, preferably wherein the at least one polymer (P) is cellulose acetate.

4. The method use according to claim 1, wherein the at least one compound (C) is selected from the group consisting of silicas, aluminas, zirconium oxides, titanium oxides, iron oxides, cerium oxides, aluminosilicates and activated carbon, preferably wherein the at least at least one compound (C) comprises precipitated silica, active carbon or both precipitated silica and active carbon.

5. The method according to claim 1, wherein the composite material has a median particle size of at least 200 μm.

6. The method according to claim 1, wherein the composite material has a pore volume (Vd1), made up of pores of diameter ranging from 3.6 to 1.000 nm, of at least 0.2 cm³/g.

7. The method according to claim 1, wherein the composite material has an average pore diameter, for pores of diameter ranging from 3.6 and 1.000 nm, of greater than 9 nm.

8. The method according to claim 1, wherein the composite material has a BET specific surface area of at least 50 m²/g.

9. The method according to claim 1, wherein the composite material has a polymer (P) content of from 10 percent to 95 percent, and a compound (C) content of from 5 percent to 90 percent.

10. A Construction material or a decorative object comprising composite material comprising at least one polymer (P) and at least one compound (C) selected from the group consisting of mineral oxides, silicoaluminates and activated carbon.

11. The Construction material or a decorative object according to claim 10, wherein the composite material has a number median particle size of at least 100 μm and a pore volume (Vd1), constituted of pores of diameter ranging from 3.6 to 1000 nm, of at least 0.2 cm³/g.

12. The Construction material or a decorative object according to claim 10, wherein the at least one polymer (P) is selected from the group consisting of: cellulose, cellulose derivatives, starch, starch derivatives, alginate or alginate derivatives, polyethylene, guars, guar derivatives, polyvinyl alcohols and derivatives of polyvinyl alcohols, preferably wherein the at least one polymer (P) is cellulose acetate.

13. The Construction material or a decorative object according to claim 10, wherein the at least one compound (C) is selected from the group consisting of silicas, aluminas, zirconium oxides, titanium oxides, iron oxides, cerium oxides, aluminosilicates and activated carbon, preferably wherein the at least at least one compound (C) comprises precipitated silica, active carbon or both precipitated silica and active carbon.

14. A method for air purification comprising removing odours or hazardous gaseous substances from air by applying a construction material or a decorative object comprising at least one composite material comprising at least one polymer (P) and at least one compound (C) selected from the group consisting of mineral oxides, silicoaluminates and activated carbon to an object, in particular a building or a vehicle.

15. A process for the manufacture of a construction material or a decorative object capable of air purification comprising removing odours or hazardous gaseous substances from air by incorporating at least one composite material comprising at least one polymer (P) and at least one compound (C) selected from the group consisting of mineral oxides, silicoaluminates and activated carbon into the construction material or the decorative object.
